(19) United States
(12) Patent Application Publication
(10) Pub. No.: US 2026/0179234 A1
(43) Pub. Date: Jun. 25, 2026

(54) INFORMATION PROCESSING METHOD, PROGRAM, AND INFORMATION PROCESSING APPARATUS

(71) Applicant: BRIDGESTONE SPORTS CO., LTD., Tokyo (JP)

(72) Inventors: Tomotaka ISHIHARA, Saitama (JP); Kazuo UCHIDA, Tokyo (JP)

(21) Appl. No.: 19/332,773

(22) Filed: Sep. 18, 2025

(30) Foreign Application Priority Data
Dec. 24, 2024 (JP) 2024-227536

(51) Int. Cl. G06T 7/246; A63B 24/00; A63B 102/32

(52) U.S. Cl. CPC G06T 7/248; A63B 24/0006; A63B 2024/0015; A63B 2102/32; A63B 2220/05; A63B 2220/807; G06T 2207/30196; G06T 2207/30221

(57) ABSTRACT

A computer-implemented information processing method includes: obtaining first data representing a motion state of a predetermined motion performed by a target person; determining a direction of enhancement for the first data; and generating second data representing a target motion state of the predetermined motion, by modifying the first data to change in the direction, within an acceptable range set in advance for changing the first data.

### CROSS-REFERENCE TO RELATED APPLICATIONS

The present application is based on and claims priority to Japanese Patent Application No. 2024-227536 filed on Dec. 24, 2024, the entire contents of which are hereby incorporated by reference.

### BACKGROUND

### 1. Field of the Invention

The present disclosure relates to an information processing method and the like.

### 2. Description of the Related Art

Conventionally, there has been known a technique for comparing a motion of a target person with a target motion (standard motion) obtained from motions of a plurality of skilled persons and presenting a comparison result (See, for example, Japanese Patent No. 6165815).

### SUMMARY

In order to achieve the above, an embodiment of the present disclosure provides
a computer-implemented information processing method, including:
obtaining first data representing a motion state of a predetermined motion performed by a target person;
determining a direction of enhancement for the first data; and
generating second data representing a target motion state of the predetermined motion, by modifying the first data to change in the direction, within an acceptable range set in advance for changing the first data.

Another embodiment of the present disclosure provides a non-transitory computer-readable recording medium having a program embodied therein for causing a computer to execute
obtaining first data representing a motion state of a predetermined motion performed by a target person;
determining a direction of enhancement for the first data; and
generating second data representing a target motion state of the predetermined motion, by modifying the first data to change in the direction of enhancement, within an acceptable range set in advance for changing the first data.

Yet another embodiment of the present disclosure provides an information processing apparatus including:
a memory; and
one or more processors coupled to the memory and configured to
obtain first data representing a motion state of a predetermined motion performed by a target person;
determine a direction of enhancement for the first data; and
generate second data representing a target motion state of the predetermined motion, by modifying the first data to change in the direction of enhancement, within an acceptable range set in advance for changing the first data.

### BRIEF DESCRIPTION OF THE DRAWINGS

FIG. 1 is a diagram illustrating an example of an information processing system;

FIG. 2 is a diagram illustrating an example of a moving image showing a state of a golf swing motion performed by a user;

FIG. 3 is a diagram illustrating another example of a moving image showing a state of a golf swing motion performed by a user;

FIG. 4 is a diagram illustrating a configurational example of a user terminal;

FIG. 5 is a diagram illustrating a configurational example of an information processing apparatus;

FIG. 6 is a diagram illustrating an outline of a processing flow of the information processing apparatus;

FIG. 7 is a functional block diagram illustrating an example of a functional configuration of the information processing system;

FIG. 8 is a diagram illustrating an example of feature point data;

FIG. 9 shows graphs illustrating an example of a method for determining an enhancement direction for motion data;

FIG. 10 shows graphs illustrating another example of a method for determining the enhancement direction for the motion data;

FIG. 11 is a graph illustrating an example of a method for setting an acceptable range;

FIG. 12 is a graph illustrating another example of the method for setting the acceptable range; and

FIG. 13 is a sequence diagram schematically illustrating an example of an operation of the information processing system.

### DETAILED DESCRIPTION OF THE PRESENT DISCLOSURE

However, when the level and physical characteristics of the skilled persons, which are used as the sources for determining the target motion, are greatly different from those of the target person, the presentation of the target motion may not be effective for enhancing the motion of the target person.

In view of the above issues, the present disclosure provides a technique capable of generating data representing the target motion which is effective for enhancing the motion of the target person.

Embodiments will be described in the following with reference to the drawings.

In the present specification, a person who uses functions of an information processing system 1 through a user terminal 200 is referred to as a “user”, and a person who engages in the work for providing the functions of the information processing system 1 to the user or management of the functions through an information processing apparatus 300 is conveniently referred to as an “operator or the like”.

### Outline of Information Processing System

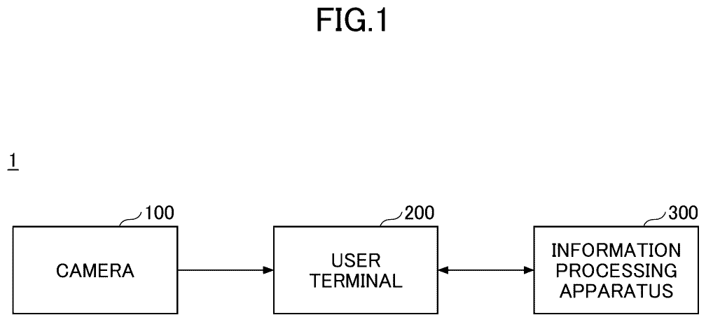

An outline of the information processing system 1 according to the present embodiment will be described with reference to FIGS. 1 to 3.

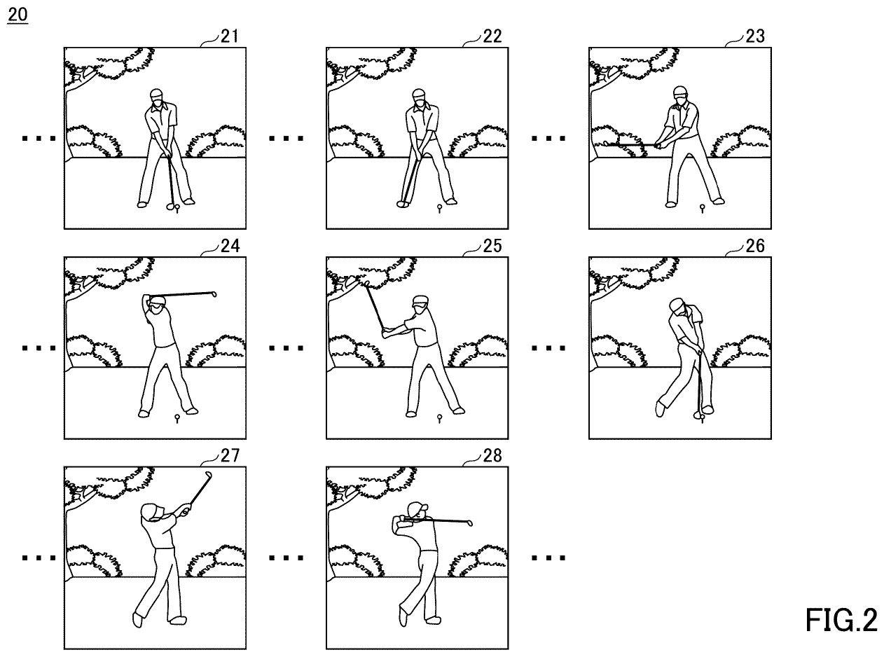

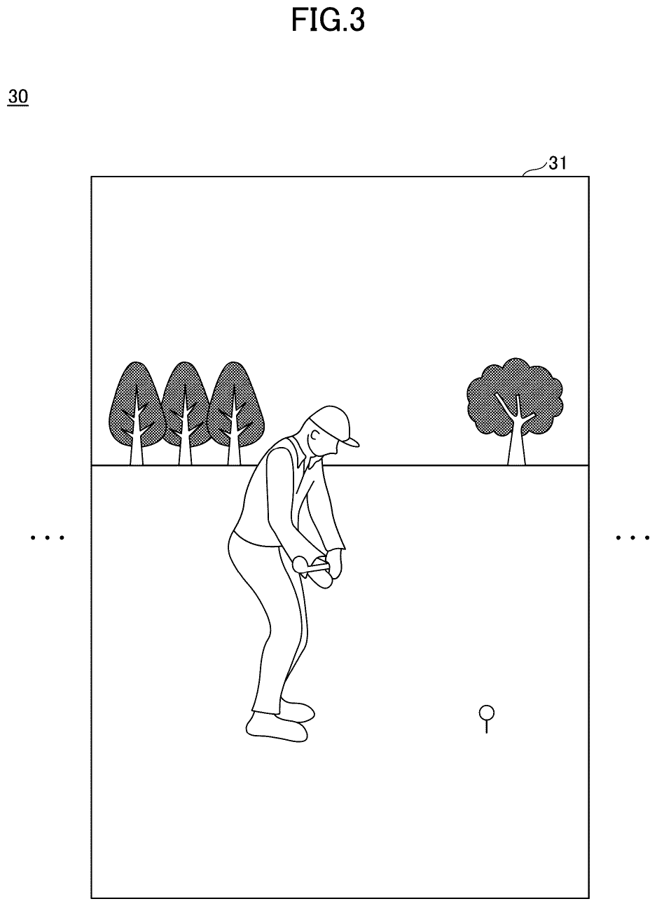

FIG. 1 is a diagram illustrating an example of the information processing system 1. FIG. 2 is a diagram illustrating an example of a moving image (moving image 20) showing a state of a golf swing motion performed by a user. FIG. 3 is a diagram illustrating another example of a moving image (moving image 30) showing a state of the golf swing motion performed by a user. Specifically, FIGS. 2 and 3 are specific examples of moving images showing a state of the golf swing motion performed by a user.

In FIG. 2, frames 21 to 28 out of all frames of the moving image 20 are illustrated as an excerpt. The frame 21 shows an address position included in a golf swing motion performed by a user. The frame 22 shows a takeaway position included in the golf swing motion performed by the user. The frame 23 shows a backswing position included in the golf swing motion performed by the user. The frame 24 shows a top-of-swing position of the backswing, included in the golf swing motion performed by the user. The frame 25 shows a halfway-down position included in the golf swing motion performed by the user. The frame 26 shows an impact position included in the golf swing motion performed by the user. The frame 27 shows a follow-through position included in the golf swing motion performed by the user. The frame 28 shows a finish position included in the golf swing motion performed by the user.

Similarly, in FIG. 3, a frame 31 out of all the frames of the moving image 30 is illustrated as an excerpt. The frame 31 shows a halfway-down position included in the golf swing motion performed by the user.

As illustrated in FIG. 1, the information processing system 1 includes a camera 100, the user terminal 200, and the information processing apparatus 300.

The information processing system 1 obtains data (hereinafter, referred to as “motion data”) representing a motion state of a predetermined motion performed by a subject, on the basis of moving image data including a state of a predetermined motion performed by the subject, obtained by the camera 100. The motion data is, for example, time-series data of a physical quantity representing the motion state of a predetermined body part of the subject or tool used by the subject in the predetermined motion. The physical quantity representing the motion state is, for example, a position, an angle, velocity, acceleration, angular velocity, angular acceleration, torque, power, and energy. The power corresponds to a work rate generated (exerted) by the predetermined body part or tool of the subject, and the energy corresponds to a work rate generated (exerted) by the predetermined body part or tool of the subject. The motion data may be time-series data of a dimensionless quantity representing the motion state of the predetermined motion performed by the subject. The information processing system 1 generates data (hereinafter, referred to as “target motion data”) representing a target motion state with respect to the predetermined motion performed by the subject, by modifying obtained motion data in the information processing apparatus 300. Thus, the information processing system 1 can present target motion data for the predetermined motion performed by the subject to the user through the user terminal 200, and can present support information for enhancing the predetermined motion performed by the subject by using the target motion data.

The subject is, for example, a user of the information processing system 1. Also, the subject may be a customer for whom the user of the information processing system 1 sells equipment (for example, hitting implements, balls, etc.). Also, the subject may be a student of a lesson to whom the user of the information processing system 1 sends advice on the swing motion. The following description will focus on the case where the subject is the user of the information processing system 1.

The predetermined motion is, for example, a golf swing motion. Also, the predetermined motion may be a golf putting motion. Also, the predetermined motion may be motions of other kinds of sports such as a baseball swing motion and pitching motion, and swing motions of tennis such as a tennis serve, forehand, backhand, and the like. Also, the predetermined motion may be a motion performed without using a tool such as a running motion or a walking motion. Also, the predetermined motion may be a different kind of motion from that in sports such as a motion related to a predetermined skill required in a factory.

The predetermined body part is a specific body part representing a characteristic of the predetermined motion performed by the user, and may be one or multiple body parts. The predetermined body part is, for example, an upper body part other than an arm part (hereinafter, simply referred to as “upper body part”), a lower body part, and an arm part. The predetermined body part may be any one or two parts selected from a group of the arm part, the upper body part, and the lower body part.

The camera 100 captures a predetermined motion performed by the user and obtains a moving image representing the state of the predetermined motion. The moving image includes a series of still images (hereinafter, referred to as “frame”).

The camera 100 is, for example, a two-dimensional camera and obtains a two-dimensional moving image. Furthermore, the camera 100 may be a three-dimensional camera capable of obtaining information with respect to a depth direction of the two-dimensional moving image in addition to the two-dimensional moving image. The information with respect to the depth direction of the two-dimensional moving image is, for example, information representing the position in the depth direction of a captured subject for each pixel of each frame included in the two-dimensional moving image.

The camera 100 obtains, for example, a moving image representing the state of the predetermined motion performed by the user in response to an operation of an image capturer different from the user performing the predetermined motion. The camera 100 may also obtain a moving image representing the state of the predetermined motion performed by the user in response to the operation performed by the user, such as by using a self-timer function or the like.

The camera 100 may obtain a moving image representing the predetermined motion performed by the user by capturing from one viewpoint or may obtain a moving image representing the predetermined motion performed by the user by capturing from a plurality of viewpoints. In the latter case, for example, a plurality of cameras 100 obtain moving images representing the predetermined motion performed by the user, as viewed from different viewpoints at the same timing. Moreover, by changing the position of one camera 100, images representing the predetermined motion performed by the user with different viewpoints may be obtained sequentially.

For example, as illustrated in FIG. 2, the camera 100 captures the golf swing motion from the front of the user while facing the user. Also, as illustrated in FIG. 3, the camera 100 may capture the golf swing motion from the rear of the user. The rear of the user means the rear of the user when the direction of the flying line (hereinafter, referred to as “imaginary flying line”) assumed by the user is “front”. The camera 100 may obtain both a moving image representing the golf swing motion taken from the front of the user and a moving image representing the golf swing motion taken from the rear of the user. In other words, the camera 100 may obtain a moving image representing the user's motion taken from one viewpoint or may obtain moving images representing the user's motion taken from multiple viewpoints.

In FIG. 1, the camera 100 and the user terminal 200 are illustrated separately, but the camera 100 may be incorporated in the user terminal 200 or may be provided separately from the user terminal 200. In the latter case, the output (that is, moving image data) of the camera 100 may be taken into the user terminal 200 by communication through a communication interface 206 described in the following, or taken into the user terminal 200 through a recording medium 201A described in the following.

The user terminal 200 is a terminal device used by the user. The user terminal 200 may be a terminal device arranged in, for example, a golf lesson facility or shop, or a terminal device owned by the user.

The user terminal 200 is, for example, a portable terminal, that is, a mobile terminal. The mobile terminal may be, for example, a smartphone, a tablet terminal, or a laptop personal computer (PC). The user terminal 200 may be a stationary terminal. The stationary terminal may be, for example, a desktop PC.

The user terminal 200 is communicably connected to the information processing apparatus 300 through a predetermined communication line. The predetermined communication line includes, for example, a local area network (LAN). The predetermined communication line may also include a wide area network (WAN). The wide area network includes, for example, an Internet network. The wide area network may also include a mobile communication network terminated at a base station or a satellite communication network that uses a communication satellite. The predetermined communication line may include, for example, a short-range communication line that conforms to predetermined wireless communication standards such as Wi-Fi, Bluetooth (registered trademark), and a private 5th generation (5G) network.

The user terminal 200 takes in a moving image representing the state of the predetermined motion performed by the user from the camera 100 and transmits the moving image to the information processing apparatus 300. The user terminal 200 presents target motion data returned from the information processing apparatus 300 to the user, or presents support information for enhancing the predetermined motion performed by the user based on the target motion data.

The information processing apparatus 300 obtains motion data of the predetermined motion performed by the user, based on the moving image representing the state of the predetermined motion performed by the user received from the user terminal 200. The information processing apparatus 300 generates target motion data for enhancing the obtained motion data of the predetermined motion performed by the user and returns the target motion data to the user terminal 200.

The information processing apparatus 300 is, for example, a server device with relatively high processing capacity. The server device may be a cloud server, an on-premises server, or an edge server. Furthermore, the information processing apparatus may be a terminal device having a lower processing capacity than the server device depending on the required processing capacity. The terminal device may be a stationary terminal device or a portable terminal device (mobile terminal).

### Configuration of Information Processing System

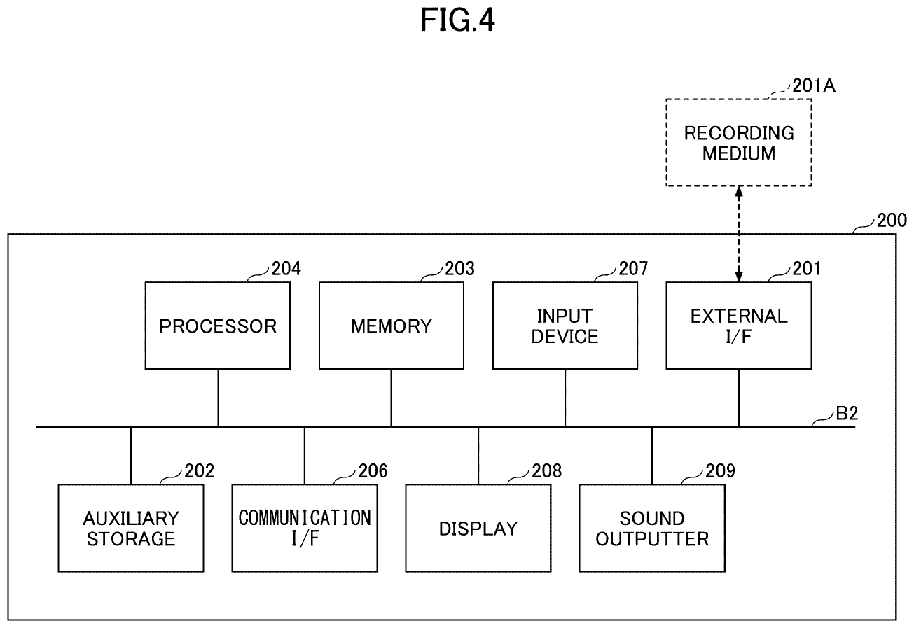

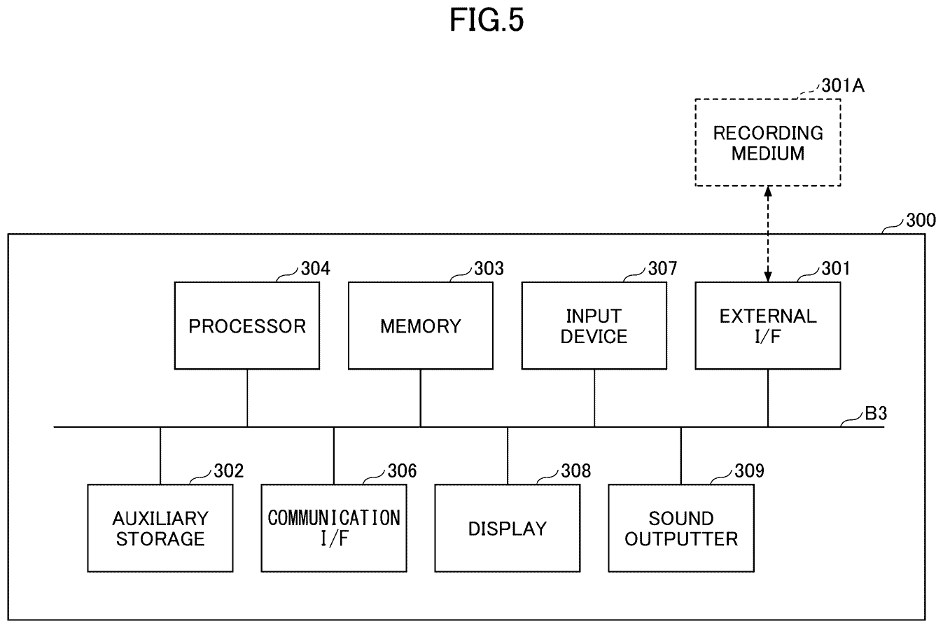

The configuration of the information processing system 1 will be described with reference to FIGS. 4 and 5 in addition to FIG. 1.

### <Configuration of User Terminal>

FIG. 4 is a block diagram illustrating a configurational example of the user terminal 200.

The functions of the user terminal 200 can be achieved by arbitrary hardware or combinations of arbitrary hardware and software. For example, as illustrated in FIG. 4, the user terminal 200 includes an external interface 201, an auxiliary storage 202, a memory 203, a processor 204, the communication interface 206, an input device 207, a display 208, and a sound outputter 209. These components are connected via a bus B2. When the camera 100 is installed in the user terminal 200 as described above, for example, the camera 100 is connected to the bus B2 in the same manner as other components.

The external interface 201 functions as an interface for reading out data from the recording medium 201A and writing data to the recording medium 201A. The recording medium 201A includes, for example, a flexible disk, a compact disc (CD), a digital versatile disc (DVD), a Blu-ray (registered trademark) disc (BD), a secure digital (SD) memory card, a universal serial bus (USB) memory, and the like. Thus, the user terminal 200 can read out various data used in processing through the recording medium 201A, store the data in the auxiliary storage 202, and install programs to achieve various functions.

The user terminal 200 may obtain various data and programs to be used in processing from an external device (for example, an information processing apparatus 300) through the communication interface 206.

The auxiliary storage 202 stores various installed programs, and also stores files, data, and the like necessary for executing various types of processing. The auxiliary storage 202 includes, for example, a hard disk drive (HDD), a solid state drive (SSD), a flash memory, and the like.

The memory 203 reads out a program from the auxiliary storage 202 and stores the program when a program start instruction is given. The memory 203 includes, for example, dynamic random access memories (DRAMs) and static random access memories (SRAMs).

The processor 204 executes various programs loaded from the auxiliary storage 202 to the memory 203, and implements various functions related to the user terminal 200 according to the programs.

The processor 204 includes, for example, a central processing unit (CPU). The processor 204 may also include, for example, a graphics processing unit (GPU), an application specific integrated circuit (ASIC), or a field-programmable gate array (FPGA).

The communication interface 206 is used as an interface for communicably connecting to an external device. Thus, the user terminal 200 can obtain moving image data from the camera 100 through the communication interface 206. Furthermore, the user terminal 200 can communicate with an external device such as the information processing apparatus 300, for example, through the communication interface 206. Furthermore, the communication interface 206 may include a plurality of types of communication interfaces in accordance with a communication method or the like between respective devices to be connected.

The input device 207 receives various inputs from the user.

The input device 207 includes, for example, an input device (hereinafter, referred to as “mechanical input device”) which receives a mechanical input from the user. The mechanical input device includes, for example, a button, a toggle, a lever, a touch panel mounted on the display 208, a touch pad provided separately from the display 208, a keyboard, a mouse, and the like.

The input device 207 may also include a voice input device capable of receiving voice inputs from the user. The voice input device may include, for example, a microphone capable of collecting user voice.

The input device 207 may also include a gesture input device capable of receiving a gesture input from the user. The gesture input device may include, for example, a camera capable of imaging a user's gesture.

The input device 207 may also include a biometric input device capable of receiving a biometric input from the user. The biometric input device may include, for example, a camera capable of obtaining image data including information about a user's fingerprint or iris.

The display 208 visually transmits information to the user by displaying an information screen, an operation screen, or the like. The display 208 is, for example, a liquid crystal display or an organic electroluminescence (EL) display.

The sound outputter 209 audibly transmits various kinds of information to the user of the user terminal 200 by outputting predetermined sounds or speech. The sound outputter 209 includes, for example, a buzzer, an alarm, a loudspeaker, or the like.

### <Configuration of Information Processing Apparatuses>

FIG. 5 is a block diagram illustrating a configurational example of the information processing apparatus 300.

The functions of the information processing apparatus 300 can be achieved by any hardware, any combination of hardware and software, or the like. For example, as illustrated in FIG. 5, the information processing apparatus 300 includes an external interface 301, an auxiliary storage 302, a memory 303, a processor 304, a communication interface 306, an input device 307, a display 308, and a sound outputter 309. These components are connected by a bus B3.

The external interface 301 functions as an interface for reading out data from the recording medium 301A and writing data to the recording medium 301A. The recording medium 301A includes, for example, a flexible disk, a CD, a DVD, a BD, an SD memory card, a USB memory, and the like. Thus, the information processing apparatus 300 can read out various data to be used in processing through the recording medium 301A, store the data in the auxiliary storage 302, and install programs to achieve various functions.

The information processing apparatus 300 may obtain various data and programs to be used in processing from an external device through the communication interface 306.

The auxiliary storage 302 stores various installed programs, and also stores files, data, and the like necessary for executing various types of processing. The auxiliary storage 302 includes, for example, an HDD, an SSD, a flash memory, and the like.

The memory 303 reads out a program from the auxiliary storage 302 and stores the program when a program start instruction is given. The memory 303 includes, for example, DRAMs and SRAMs.

The processor 304 executes various programs loaded from the auxiliary storage 302 to the memory 303, and implements various functions related to the information processing apparatus 300 according to the programs. The processor 304 includes, for example, a CPU. The processor 304 may also include, for example, a GPU or an ASIC.

The communication interface 306 is used as an interface for communicably connecting to an external device. Thus, the information processing apparatus 300 can communicate with external devices such as the user terminal 200 through the communication interface 306. Furthermore, the communication interface 306 may include a plurality of types of communication interfaces in accordance with the communication method or the like between respective devices to be connected.

The input device 307 receives various inputs from the operator or the like.

The input device 307 includes, for example, a mechanical input device which receives mechanical input operation from the operator or the like. The mechanical input device includes, for example, a button, a toggle, a lever, a touch panel mounted on the display 308, a touch pad provided separately from the display 308, a keyboard, a mouse, etc.

The input device 307 also includes, for example, a voice input device capable of receiving voice inputs from the operator or the like. The voice input device includes, for example, a microphone which can collect the voice of the operator or the like.

The input device 307 includes, for example, a gesture input device capable of accepting gesture inputs from the operator or the like. The gesture input device may include, for example, a camera capable of imaging gestures of the operator or the like.

The input device 307 also includes, for example, a biometric input device capable of receiving biometric input from the operator or the like. The biometric input device includes, for example, a camera capable of obtaining image data including information on fingerprints and iris of the operator or the like.

The display 308 visually conveys various kinds of information to the operator or the like by displaying an information screen or an operation screen to the operator or the like. The display 308 is, for example, a liquid crystal display or an organic EL display.

The sound outputter 309 transmits various kinds of information to the operator or the like of the information processing apparatus 300 by sound. The sound outputter 309 is, for example, a buzzer, an alarm, a loudspeaker, etc.

### Outline of Processing Executed in Information Processing System

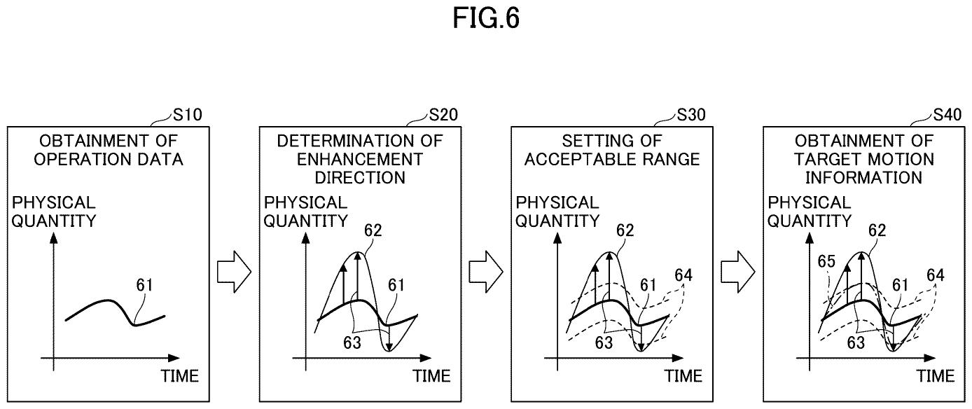

An outline of the processing executed in the information processing system 1 will be described with reference to FIG. 6.

FIG. 6 is a diagram illustrating an outline of a processing flow of the information processing apparatus 300.

### <Obtainment of Motion Data>

The information processing apparatus 300 obtains motion data 61 with respect to the predetermined motion performed by the user based on a moving image obtained from the user terminal 200, in which the predetermined motion performed by the user is recorded (step S10).

For example, the information processing apparatus 300 extracts feature points of the user's body parts and tool possessed by the user from each frame of moving image data. Based on the changes in the position of the feature points in each frame, the information processing apparatus 300 obtains motion data as time series data of physical quantities representing the motion state of the user's body parts or tool.

### <Determination of Enhancement Direction>

The information processing apparatus 300 determines (step S20) an enhancement direction 63 of the motion data 61 based on the assumption that target motion data 65 is generated by modifying the motion data 61 obtained in step S10, which is the data as the starting point of the modification.

For example, the information processing apparatus 300 determines the enhancement direction 63 with respect to the motion data 61 based on reference data 62 representing the motion state of the predetermined motion.

The reference data 62 is motion data representing the motion state of the predetermined motion corresponding to a state in which performance higher than in the motion data 61 can be demonstrated in predetermined evaluation items. The predetermined evaluation items are, for example, the degree of exertion of energy, the degree of exertion of power, speed (velocity or angular velocity), efficiency, and the like. Thus, the information processing apparatus 300 compares the motion data 61 and the reference data 62 in the time series of the same motion section, and can determine the direction in which the motion data 61 is brought closer to the reference data 62 at each timing as the enhancement direction 63.

### <Setting of Acceptable Range>

The information processing apparatus 300 sets an acceptable range 64 of the change to be made in the motion data 61 on the assumption that the target motion data 65 is generated by modifying the motion data 61 obtained in step S10, which is the data as the starting point of the modification (step S30). The acceptable range 64 may be set as the tolerance of the change. The acceptable range 64 is set in consideration of, for example, the moving range of the physical body part of the user and the skill level of the user in the predetermined motion. Thus, when the motion data 61, which is the starting point of the modification, is modified to change the motion data 61 in the enhancement direction 63, for example, it is possible to suppress the occurrence of a situation in which the target motion, which is difficult to achieve based on the physical characteristics and the skill level of the user in the predetermined motion, is generated. Therefore, the information processing apparatus 300 can generate effective target motion data for enhancing the performance of the predetermined motion performed by the user in step S40 as described in the following.

### <Obtainment of Target Motion Information>

The information processing apparatus 300 obtains (step S40) the target motion data 65 by modifying the motion data 61 obtained in step S10 in the enhancement direction 63 determined in step S20 and based on the acceptable range 64 set in step S30. Specifically, the information processing apparatus 300 obtains the target motion data 65 by modifying the motion data 61 to change in the enhancement direction 63 so as to make the range of the motion data 61 fall within the acceptable range 64.

Thus, the information processing system 1 can present the target motion data to the user through the user terminal 200 for enhancing the predetermined motion performed by the user, and can present support information for enhancing the predetermined motion based on the target motion data.

### Functional Configuration of Information Processing System

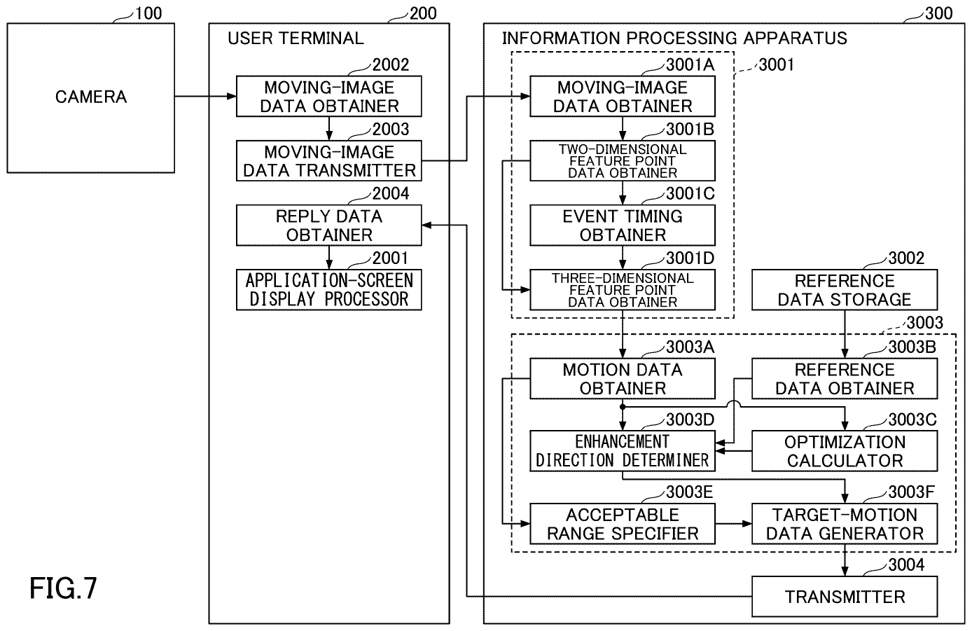

A functional configuration of the information processing system 1 will be described with reference to FIGS. 7 to 12.

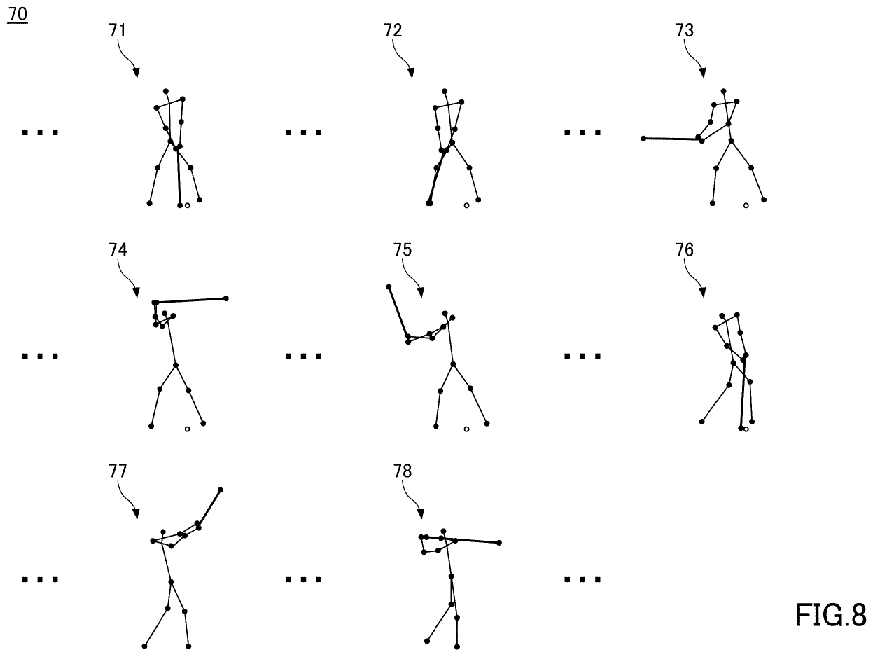

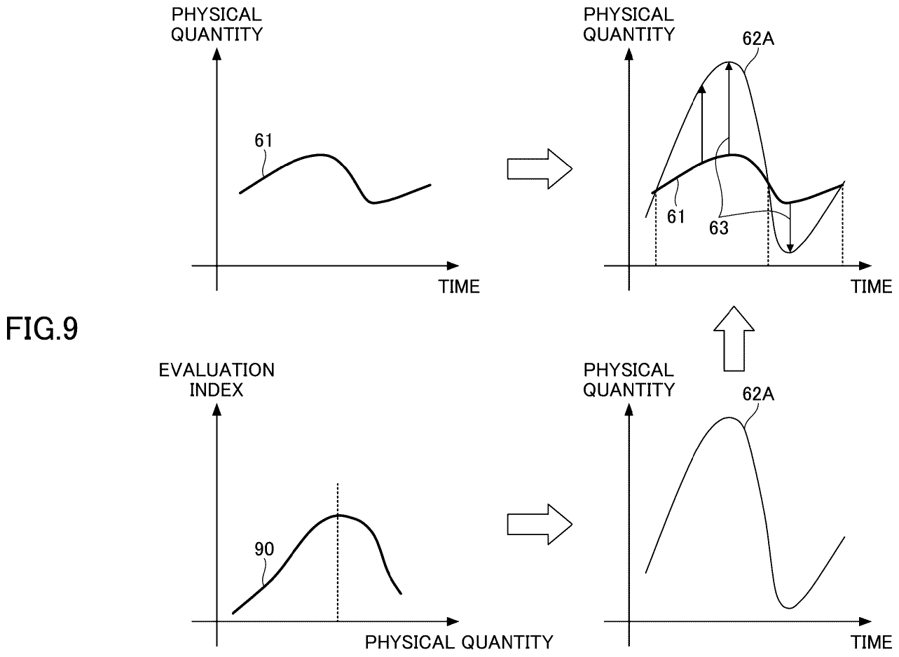

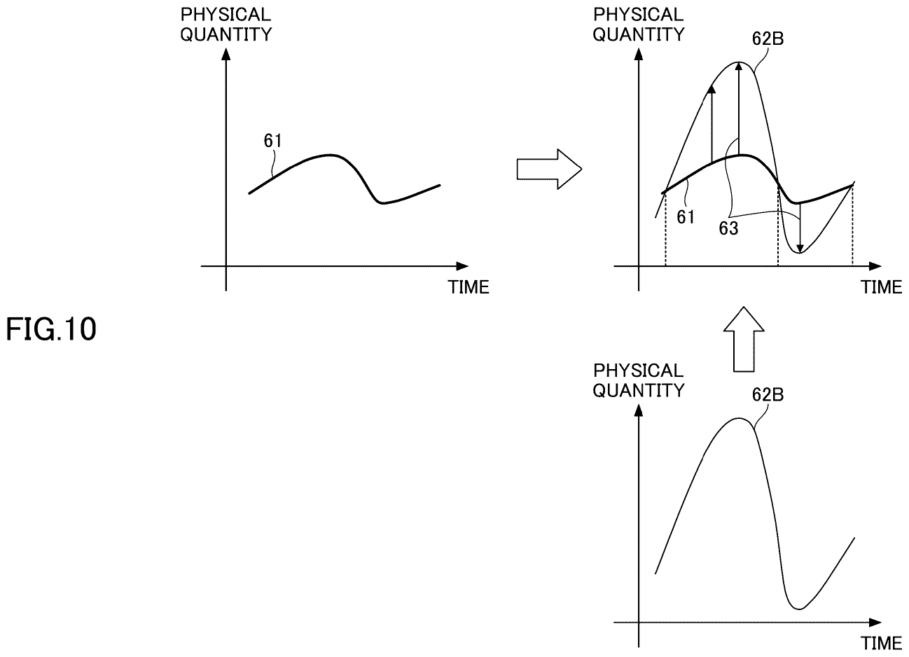

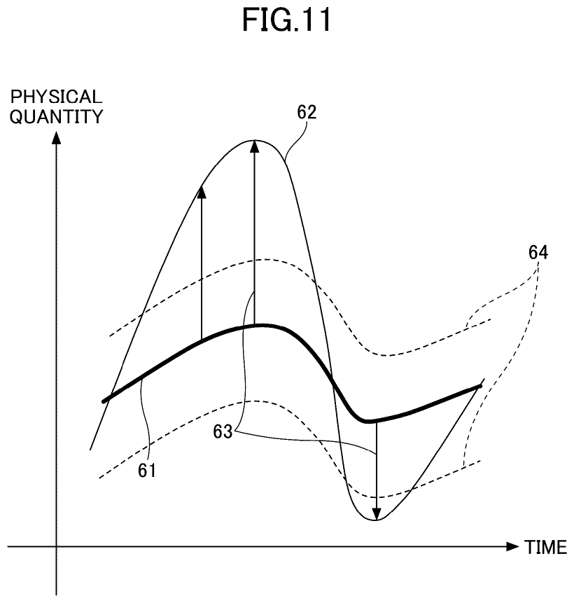

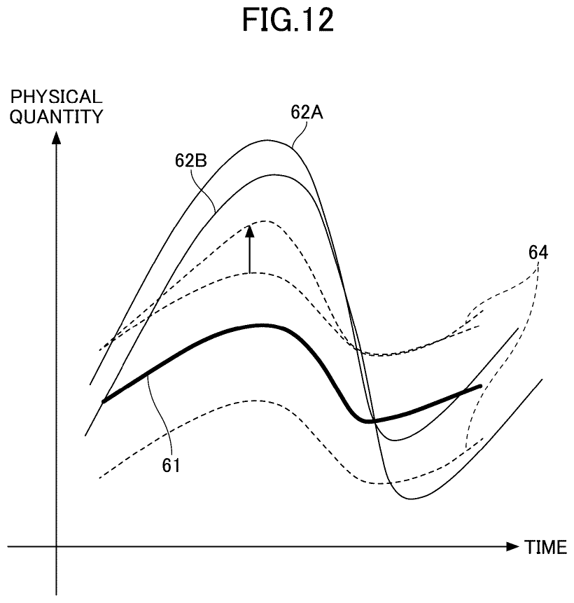

FIG. 7 is a functional block diagram illustrating an example of the functional configuration of the information processing system 1. FIG. 8 is a diagram illustrating an example of feature point data. FIG. 9 shows graphs illustrating an example of a method for determining the enhancement direction 63 for motion data. FIG. 10 shows graphs illustrating another example of the method for determining the enhancement direction 63 for the motion data. FIG. 11 is a graph illustrating an example of the method for setting the acceptable range 64. FIG. 12 is a graph illustrating another example of the method for setting the acceptable range 64.

Specifically, FIG. 8 is a diagram illustrating feature points representing the user's motion for each of a plurality of frames included in a moving image representing the user's golf swing motion. FIG. 8 schematically visualizes data 70 of the feature points (black circles in the diagram) representing the user's motion for each of the plurality of frames in the moving image representing the user's golf swing motion. In FIG. 8, data 71 to 78 of the feature points for each frame of a part (specifically, frames 21 to 28) of all frames included in the moving image 20 as illustrated in FIG. 2 are shown. The data 71 represents data of the feature points corresponding to the frame 21 showing the address position included in the user's golf swing motion. Data 72 represents data of the feature points corresponding to frame 22 showing the takeaway position included in the user's golf swing motion. Data 73 represents data of the feature points corresponding to frame 23 showing the backswing position included in the user's golf swing motion. Data 74 represents data of the feature points corresponding to frame 24 showing the top-of-swing position included in the user's golf swing motion. Data 75 represents data of the feature points corresponding to frame 25 showing the halfway-down position included in the user's golf swing motion. Data 76 represents data of the feature points corresponding to frame 26 showing the impact position included in the user's golf swing motion. Data 77 represents data of the feature points corresponding to frame 27 showing the follow-through position included in the user's golf swing motion. Data 78 represents data of the feature points corresponding to frame 28 showing the finish position included in the user's golf swing motion.

As illustrated in FIG. 7, the user terminal 200 includes an application-screen display processor 2001, a moving-image data obtainer 2002, a moving-image data transmitter 2003, and a reply data obtainer 2004. These functions are achieved, for example, when an application program (hereinafter, simply referred to as “application”) installed in the auxiliary storage 202 is loaded into the memory 203 and then executed by the processor 204.

The application-screen display processor 2001 causes the display 208 to display a screen (hereinafter, referred to as “application screen”) related to the application.

The moving-image data obtainer 2002 obtains data of a moving image representing a predetermined motion performed by the user from the camera 100. For example, the moving-image data obtainer 2002 obtains data of a moving image representing a predetermined motion performed by the user from the camera 100 in response to an input from the user on a predetermined application screen by using the input device 207. At this time, the moving-image data obtainer 2002 may obtain a moving image already captured by the camera 100, or may obtain the latest moving image obtained (captured) by the camera 100 in real time. The moving image data includes data of a two-dimensional moving image. In addition to the data of the two-dimensional moving image, the moving image data may include information with respect to the depth direction of the two-dimensional moving image.

The moving-image data transmitter 2003 transmits the moving image data obtained by the moving-image data obtainer 2002 and representing the state of the predetermined motion performed by the user, to the information processing apparatus 300 through the communication interface 206. For example, the moving-image data transmitter 2003 transmits moving image data obtained from the camera 100 to the information processing apparatus 300 in response to an input from the user on the predetermined application screen by using the input device 207.

The reply data obtainer 2004 obtains reply data received from the information processing apparatus 300 and including target motion data of a predetermined motion performed by the user.

The application-screen display processor 2001 causes the display 208 to display, for example, an application screen including target motion data of a predetermined motion performed by the user included in the reply data obtained by the reply data obtainer 2004. Thus, the user can visually confirm the target motion data. In addition, the application-screen display processor 2001 may cause the display 208 to display the motion data of a predetermined motion performed by the user obtained based on the moving image data and the target motion data such that they can be compared. In this case, the reply data includes not only the target motion data but also the motion data of the predetermined motion performed by the user. Thus, the user can readily grasp the direction of enhancement with respect to the user's predetermined motion and the amount of enhancement to be targeted.

In addition, the application-screen display processor 2001 may cause the display 208 to display an application screen provided with support information for enhancing the user's predetermined motion, based on the target motion data of the user's predetermined motion which is included in the reply data obtained by the reply data obtainer 2004.

As illustrated in FIG. 7, the information processing apparatus 300 includes an image processor 3001, a reference data storage 3002, a target motion data obtainer 3003, and a transmitter 3004. These functions are achieved, for example, by loading a program installed in the auxiliary storage 302 into the memory 303 and executing the program by the processor 304. In addition, the functions of the reference data storage 3002 are achieved by a storage area defined in the auxiliary storage 302 or the like.

The image processor 3001 includes a moving-image data obtainer 3001A, a two-dimensional feature point data obtainer 3001B, an event timing obtainer 3001C, and a three-dimensional feature point data obtainer 3001D. These functions are achieved, for example, by loading a program installed in the auxiliary storage 302 into the memory 303 and executing it in the processor 304.

The moving-image data obtainer 3001A obtains data of a moving image representing the swing motion of the user received from the user terminal 200.

The two-dimensional feature point data obtainer 3001B extracts (detects) a plurality of feature points related to the predetermined motion performed by the user as the subject, on the image displayed in each frame included in the moving image obtained by the moving-image data obtainer 3001A by using known image processing techniques. Thus, the two-dimensional feature point data obtainer 3001B can obtain time-series data (hereinafter, referred to as “two-dimensional feature point data”) representing a plurality of feature points for each frame included in the moving image in two dimensions. The known image processing techniques include, for example, image recognition techniques for detecting (estimating) skeletal information of a person or an object captured in an image, which are generally referred to as bone detection or bone estimation.

Furthermore, when the moving-image data obtainer 3001A obtains data of a moving image viewed from a plurality of different viewpoints, the two-dimensional feature point data obtainer 3001B obtains two-dimensional feature point data for each of a plurality of moving images corresponding to the plurality of viewpoints.

For example, as illustrated in FIG. 8, the two-dimensional feature point data obtainer 3001B extracts a plurality of feature points related to the swing motion of the user as the subject for every frame of the moving image.

The plurality of feature points include, for example, feature points (hereinafter, referred to as “physical feature points”) representing a body part of the user as the subject on the image displayed in the frame. The physical feature points represent, for example, joint positions in the skeleton of the user, and the physical feature points included in the plurality of feature points include points on the image corresponding to the head, shoulders, elbows, wrists, hips, knees, ankles, etc. Thus, the two-dimensional feature point data obtainer 3001B can obtain two-dimensional feature point data representing the positions and posture angles of the body parts of the user in two dimensions.

Furthermore, the plurality of feature points may include feature points representing parts of the tool held by the user. For example, as illustrated in FIG. 8, a feature point corresponding to the head of the club held by the user is extracted. Thus, the two-dimensional feature point data obtainer 3001B can obtain two-dimensional feature point data representing the positions and posture angles of the parts of the tool held by the user in two dimensions.

Furthermore, the plurality of feature points may include a feature point representing the target ball shot by a hitting implement.

The two-dimensional feature point data obtainer 3001B may adjust the coordinate system or the scale of the coordinate system of the two-dimensional feature point data. For example, the two-dimensional feature point data obtainer 3001B obtains two-dimensional feature point data in a coordinate system that is based on the scale of the real world by using the subject (that is, the user) as a reference.

The event timing obtainer 3001C obtains the timing of a predetermined event in the time series of the two-dimensional feature point data, based on the two-dimensional feature point data obtained by the two-dimensional feature point data obtainer 3001B. When the two-dimensional feature point data obtainer 3001B obtains a plurality of two-dimensional feature point data obtained from a plurality of viewpoints, the event timing obtainer 3001C obtains, for each of the plurality of two-dimensional feature point data, the timing of the predetermined event in the time series of the target two-dimensional feature point data.

The predetermined event is a predetermined event in a predetermined motion. For example, the predetermined event is an event representing a motion state at the start or end of a predetermined motion among all frames included in a moving image, an event representing a motion state at the start of each motion section when the predetermined motion is divided into a plurality of motion sections, or an event representing a specific motion state in each motion section. Specifically, for example, a predetermined event in the swing motion of golf includes the address, takeaway, backswing, top-of-swing, halfway-down, impact, follow-through, and the like. The number of predetermined events for which timing is to be obtained in the time series of two-dimensional feature point data may be one or more than one.

The event timing obtainer 3001C obtains the timing of a predetermined event, for example, by estimating data of one time point that corresponds to a predetermined event from among a plurality of data with respect to each time point (hereinafter, referred to as “two-dimensional time-point data” for convenience) included in the two-dimensional feature point data. In this case, the event timing obtainer 3001C selectively estimates the timing of the predetermined event from a discrete time system defined by each piece of two-dimensional time-point data included in the two-dimensional feature point data. In addition, the event timing obtainer 3001C may determine the time series of the two-dimensional feature point data as a continuous-time system and estimate the timing of the predetermined event in the continuous-time system. In this case, the timing of the predetermined event may be estimated as timing in between two time-points that correspond to adjacent time-points in the two-dimensional time-point data.

The event timing obtainer 3001C can obtain the timing of a predetermined event in the time series of the two-dimensional feature point data by using a known method.

For example, the event timing obtainer 3001C obtains the timing of a predetermined event by estimating the timing of the predetermined event based on the similarity between the two-dimensional feature point data at each time point and the reference two-dimensional feature point data (reference motion data) corresponding to the predetermined event (See, for example, Japanese Laid-Open Patent Application No. 2024-108340, etc.).

The event timing obtainer 3001C may also estimate the timing of a predetermined event based on whether or not the physical quantity representing the motion state of a specific feature point obtained from each piece of two-dimensional time-point data included in the two-dimensional feature point data satisfies the condition corresponding to the predetermined event. For example, the speed of the head of the golf club becomes zero at the top timing in a golf swing motion. Therefore, the event timing obtainer 3001C can obtain the top event timing by extracting the two-dimensional time data satisfying the condition that the speed of the feature point corresponding to the head of the club can be determined to be zero from among the plurality of two-dimensional time data included in the two-dimensional feature point data.

Furthermore, the operator may be able to use the input device 307 to perform an input for designating a frame corresponding to a predetermined event from among all frames included in the moving image while viewing the moving image displayed on the display 308. In this case, the event timing obtainer 3001C can obtain the timing of a predetermined event in response to a predetermined input from the operator via the input device 307.

Furthermore, the user may be able to use the input device 207 to perform an input for designating a frame corresponding to a predetermined event from among all frames of the moving image while viewing the moving image displayed on the display 208. In this case, the event timing obtainer 3001C can obtain the timing of a predetermined event in response to a predetermined input from the user via the input device 207.

The three-dimensional feature point data obtainer 3001D obtains time-series data (hereinafter, referred to as “three-dimensional feature point data”) representing a plurality of feature points for each frame included in the moving image obtained by the moving-image data obtainer 3001A in three dimensions.

For example, the three-dimensional feature point data obtainer 3001D obtains three-dimensional motion data representing a user's swing motion based on a plurality of two-dimensional feature point data corresponding to a plurality of viewpoints. Specifically, the three-dimensional feature point data obtainer 3001D estimates a three-dimensional position for each of the plurality of feature points by collating data of the same kind of feature points in the plurality of two-dimensional time-point data obtained at the same timing with different viewpoints, and thus can obtain three-dimensional motion data.

The reference data storage 3002 stores reference data 62B as an example of the reference data 62 described above.

The reference data 62B is, for example, time-series data representing a motion state of a predetermined motion performed by a skilled person. In this case, the reference data 62B may be time-series data representing a motion state of a predetermined motion by a specific skilled person, or data representing an average of time-series data representing a motion state of a predetermined motion performed by each of the plurality of skilled persons.

Furthermore, the reference data 62B may be time-series data representing a motion state of a predetermined motion performed by a person obtained by solving an optimization issue for optimizing a predetermined evaluation item.

Furthermore, the reference data 62B may be obtained by a trained model capable of outputting time-series data representing the motion state of a person performing a predetermined motion in response to a predetermined input. The predetermined input is, for example, information on a person's attribute (body size, gender, etc.). The trained model is, for example, a model in which supervised learning is performed by using time-series data representing the motion state of a skilled person performing a predetermined motion as training data. The trained model may be a model in which reinforcement learning is performed to optimize the reward corresponding to a predetermined evaluation item.

The target motion data obtainer 3003 includes a motion data obtainer 3003A, a reference data obtainer 3003B, an optimization calculator 3003C, an enhancement direction determiner 3003D, an acceptable range specifier 3003E, and a target-motion data generator 3003F. These functions are achieved, for example, when a program installed in the auxiliary storage 302 is loaded into the memory 303 and executed by the processor 304.

The motion data obtainer 3003A obtains time-series data (motion data 61) representing the motion state of a predetermined motion performed by the user based on the three-dimensional feature point data.

For example, the motion data obtainer 3003A obtains motion data 61 between two specific events based on data (hereinafter, referred to as “three-dimensional time-point data”) at each time point between two specific events, among the three-dimensional feature point data, obtained by the event timing obtainer 3001C. The specific two events correspond to, for example, the timing of the start and the timing of the end of a predetermined motion. In the case of the golf swing motion, for example, the specific two events are the address position and the finish position.

The reference data obtainer 3003B reads out the reference data 62B from the reference data storage 3002 to obtain the reference data 62B.

The optimization calculator 3003C performs optimization calculation of an evaluation function 90.

The enhancement direction determiner 3003D determines the enhancement direction 63 of the motion data 61.

For example, as illustrated in FIG. 9, the enhancement direction determiner 3003D determines the enhancement direction 63 by using the evaluation function 90.

The evaluation function 90 is a function representing the relationship between the physical quantity corresponding to the motion data and the evaluation index for the predetermined evaluation item. The optimization calculator 3003C performs optimization calculation for the evaluation function 90, and generates data (hereinafter, referred to as “optimum motion data”) 62A representing the motion state of the predetermined motion such that the evaluation function 90 can be optimized. Thus, the enhancement direction determiner 3003D can determine the direction in which the motion data 61 approaches the optimum motion data 62A as the enhancement direction 63.

Also, as illustrated in FIG. 10, for example, the reference data 62B is used to determine the enhancement direction 63. Thus, the enhancement direction determiner 3003D can determine the direction in which the motion data 61 approaches the reference data 62B as the enhancement direction 63.

The acceptable range specifier 3003E sets the acceptable range 64 for the motion data 61.

For example, as illustrated in FIG. 11, the acceptable range specifier 3003E sets a range of a certain width by using the motion data 61 as a reference, as the acceptable range 64. In this case, the acceptable range 64 is set, for example, as a range in which the amount of change in at least one of the joint position or the joint angle of the user falls below a predetermined upper limit value. Thus, by generating the target motion data 65 that falls within the acceptable range 64, the information processing apparatus 300 can generate the target motion data 65 within a range that is physically reasonable for the user, based on the predetermined motion performed by the user.

Also, as illustrated in FIG. 12, the acceptable range specifier 3003E may set the acceptable range 64 based on the weighting specified between the motion data 61, the optimum motion data 62A, and the reference data 62B. As the weighting of the optimum motion data 62A and the reference data 62B becomes relatively larger than that of the motion data 61, the acceptable range 64 approaches the optimum motion data 62A and the reference data 62B (see the arrow in FIG. 12). In contrast to this, as the weighting of the optimum motion data 62A and the reference data 62B becomes relatively smaller than that of the motion data 61, the acceptable range 64 moves away from the optimum motion data 62A and the reference data 62B. As a result, it is possible to finely adjust to what level the amount of change between the motion data 61 and the reference data 62 is to be permitted. Therefore, the information processing apparatus 300 can generate target motion data 65 that is more effective for the user by achieving both the generation of target data within a range that is physically reasonable for the user and a higher level of enhancement.

The acceptable range specifier 3003E may set the acceptable range 64 by weighting set between the motion data 61 and either one of the optimum motion data 62A or the reference data 62B.

The target-motion data generator 3003F generates and obtains the target motion data 65 by modifying the motion data 61 based on the enhancement direction 63 and the acceptable range 64. Specifically, the target-motion data generator 3003F generates the target motion data 65 by modifying the motion data 61 in the enhancement direction 63 such that the motion data 61 falls within the acceptable range 64.

The transmitter 3004 transmits reply data including the target motion data obtained by the target motion data obtainer 3003 to the user terminal 200 through the communication interface 306. Thus, the user terminal 200 can present the target motion data to the user or present support information for enhancing the predetermined motion performed by the user based on the target motion data.

### Specific Example of Operation of Information Processing System

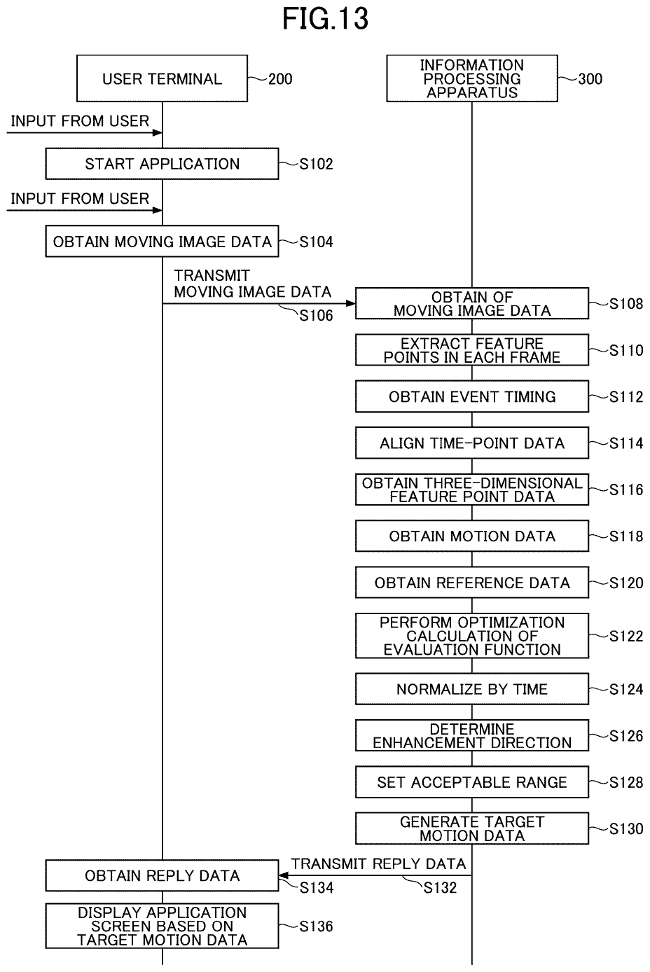

A specific example of the operation of the information processing system 1 according to the present embodiment will be described with reference to FIG. 13.

FIG. 13 is a sequence diagram schematically illustrating an example of the operation of the information processing system 1.

As illustrated in FIG. 13, the user terminal 200 starts an application in response to a predetermined input from the user by using the input device 207 (step S102).

After the completion of the processing in step S102, the moving-image data obtainer 2002 obtains (step S104) moving image data representing a predetermined motion performed by the user from the camera 100 in response to a predetermined input from the user on the predetermined application screen by using the input device 207.

After the completion of the processing in step S104, the moving-image data transmitter 2003 transmits (step S106) the moving image data to the information processing apparatus 300 through the communication interface 206.

The moving-image data obtainer 3001A obtains (step S108) the moving image data transmitted (uploaded) from the user terminal 200 in the processing of step S106.

After the completion of the processing of step S108, the two-dimensional feature point data obtainer 3001B obtains two-dimensional feature point data by extracting (step S110) feature points representing the user's swing motion in each frame of the moving image data.

After the completion of the processing of step S110, the event timing obtainer 3001C obtains (step S112) event timing for each two-dimensional feature point data of the two viewpoints.

After the completion of the processing of step S112, the three-dimensional feature point data obtainer 3001D compares the event timing obtained with respect to the two-dimensional feature point data of the two viewpoints and aligns (step S114) the two-dimensional time-point data in the time series, between two datasets of the two-dimensional feature point data of the two viewpoints.

After the completion of the processing of step S114, the three-dimensional feature point data obtainer 3001D obtains (step S116) three-dimensional feature point data based on the two-dimensional feature point data of the two viewpoints that have been aligned in the processing of step S114.

After completion of the processing in step S116, the motion data obtainer 3003A obtains (step S118) motion data 61 based on the three-dimensional feature point data.

After completion of the processing in step S118, the reference data obtainer 3003B obtains (step S120) reference data 62B by reading out the reference data 62B from the reference data storage 3002.

After completion of the processing in step S120, the optimization calculator 3003C performs (step S122) optimization calculation for the evaluation function 90 and obtains optimum motion data 62A.

After completion of the processing in step S122, the enhancement direction determiner 3003D normalizes (step S124) the motion data 61 and the reference data 62 (optimum motion data 62A and reference data 62B) by the time between the start and the end of the predetermined motion.

Thus, the motion data 61 and the reference data 62 can be synchronized in time series.

After the completion of the processing in step S124, the enhancement direction determiner 3003D determines (step S126) the enhancement direction 63 based on the motion data 61, the optimum motion data 62A, and the reference data 62B.

After the completion of the processing in step S126, the acceptable range specifier 3003E sets (step S128) the acceptable range 64.

After the completion of the processing in step S128, the target-motion data generator 3003F obtains (generates) (step S130) the target motion data 65 by modifying the motion data 61 based on the enhancement direction 63 and the acceptable range 64.

After the completion of the processing in step S130, the transmitter 3004 transmits (step S132) reply data including the target motion data generated in the processing in step S130 to the user terminal 200.

The reply data obtainer 2004 obtains (step S134) the reply data transmitted from the information processing apparatus 300 in the processing of step S132.

After the completion of the processing in step S134, the application-screen display processor 2001 causes the display 208 to display (step S136) a predetermined application screen based on the target motion data included in the reply data.

### Other Embodiments

Other embodiments will be described in the following.

The above-described embodiment may be modified or changed as appropriate. Hereinafter, examples in which modifications or changes are made to the above-described embodiment are conveniently referred to as “modified examples”.

For example, in the above-described embodiment, the functions of the user terminal 200 and the information processing apparatus 300 may be implemented by one information processing apparatus or distributed by three or more information processing apparatuses. For example, the functions of the information processing apparatus 300 are transferred to the user terminal 200. For example, the function of the information processing apparatus 300 is achieved by the first information processing apparatus having the function of the image processor 3001 and the second information processing apparatus having the function of the reference data storage 3002, the target motion data obtainer 3003, and the transmitter 3004.

Moreover, in the above-described embodiment and its modification, the event timing obtainer 3001C may estimate the timing of a predetermined event based on the measurement data of a motion sensor attached to the user's body when the moving image data is obtained. For example, the event timing obtainer 3001C estimates the timing of a predetermined event based on whether or not the physical quantity (e.g. velocity, acceleration, etc.) representing the motion state of a specific part of the user's body obtained based on the output of the motion sensor satisfies the condition corresponding to the predetermined event.

Moreover, in the above-described embodiment and its modification, the three-dimensional feature point data obtainer 3001D obtains the three-dimensional feature point data of a predetermined motion performed by the user captured in the moving image data based on the moving image data, but the three-dimensional feature point data may be obtained by other methods. For example, the three-dimensional feature point data obtainer 3001D may obtain the three-dimensional feature point data of a predetermined motion performed by the user by using a motion capture technique. In this case, the user performs a swing motion with a plurality of motion capture markers attached to the user's body. In addition, the three-dimensional feature point data obtainer 3001D may obtain the three-dimensional feature point data representing a predetermined motion performed by the user, by using information with respect to the depth direction of the two-dimensional moving image.

In the above-described embodiment and its modification, the motion data obtainer 3003A obtains motion data 61 of a predetermined motion performed by the user based on the three-dimensional feature point data, but the motion data 61 may be obtained by other methods. For example, the motion data obtainer 3003A obtains motion data 61 of a predetermined motion performed by the user, based on the measurement data of the motion sensor attached to the user's body.

### Advantageous Effect

Advantageous effects of the information processing method, the program, and the information processing apparatus according to the present embodiment will be described.

In the first aspect of the present embodiment, an information processing method including obtaining, determining, and generating is provided. The obtaining is, for example, step S118. The determining is, for example, step S126. The generating is, for example, step S130. Specifically, in the obtaining, the information processing apparatus obtains first data representing a motion state of a predetermined motion performed by a target person. The first data is, for example, the motion data 61 described above. In the determining, the information processing apparatus determines the direction of enhancement with respect to the first data. Then, the information processing apparatus generates second data representing a target motion state of the predetermined motion by modifying the first data to change the first data in the direction within an acceptable range for changing the first data. The second data is, for example, the target motion data 65 described above. The information processing apparatus is, for example, at least one of the information processing apparatus 300 or the user terminal 200 described above.

Furthermore, in the first aspect of the present embodiment, a program for causing the information processing apparatus to execute the obtaining, the determining, and the generating may be provided.

Furthermore, in the first aspect of the present embodiment, an information processing apparatus including a memory, and one or more processors coupled to the memory and configured to obtain, determine, and generate may be provided. The information processing apparatus is, for example, the information processing apparatus 300 described above. The information processing apparatus may be the user terminal 200 described above. The obtaining is, for example, the obtaining by the motion data obtainer 3003A described above. The determining is, for example, the determining by the enhancement direction determiner 3003D described above. The generating is, for example, the determining by the target-motion data generator 3003F described above. Specifically, in the obtaining, first data representing the motion state of the predetermined motion performed by a target person is obtained. In the determining, the direction of enhancement for the first data is determined. In the generating, second data representing the target motion state of the predetermined motion is generated by modifying the first data to change in the direction of enhancement within an acceptable range for changing the first data that is set in advance.

Thus, the information processing apparatus can change the first data representing the motion state of the predetermined motion performed by the target person in the direction of enhancement for the amount within an acceptable range and generate second data representing the target motion state. Therefore, the information processing apparatus can generate data representing a target motion that is effective for enhancing the motion of the target person.

In the second aspect of the present embodiment, on the premise of the first aspect described above, the direction may be determined in the determining based on an evaluation function representing the objective of the enhancement of the first data. The evaluation function is, for example, the evaluation function 90 described above.

Thus, the information processing apparatus can appropriately determine the direction of enhancement for the first motion data.

In the third aspect of the present embodiment, on the premise of the second aspect described above, the evaluation function may be a function representing at least one of a position, angle, energy, power, torque, angular velocity, angular acceleration, velocity, or acceleration of a predetermined body part of the target person or a tool used by the target person at the time of the predetermined motion.

Thus, the information processing apparatus can appropriately determine the direction of enhancement for the first motion data.

Furthermore, in the fourth aspect of the present embodiment, on the premise of any one of the first to third aspects described above, in the determining, the direction may be determined to be a direction in which the first data approaches the third data representing the reference motion state of the predetermined motion. The third data is, for example, the reference data 62B described above.

Thus, the information processing apparatus can appropriately determine the direction of enhancement for the first motion data.

In the fifth aspect of the present embodiment, on the premise of the fourth aspect described above, the third data may be data representing the motion state of a skilled person in the predetermined motion, data representing the motion state of the predetermined motion that is optimized based on the objective of enhancement, or data representing the motion state of the predetermined motion that has been generated from the trained model.

Thus, the information processing apparatus can appropriately determine the direction of enhancement for the first motion data.

Furthermore, in the sixth aspect of the present embodiment, on the premise of any one of the first to fifth aspects, the first data and the third data may be normalized by the time between the first event and the second event in the predetermined motion.

Thus, the information processing apparatus can synchronize the predetermined motion in the first data with the predetermined motion in the third data. Therefore, the information processing apparatus can more appropriately generate data representing the target motion which is effective for enhancing the motion of the target person.

In the seventh aspect of the present embodiment, on the premise of any one of the first to sixth aspects, the acceptable range may be a range in which the amount of the change in at least one of the joint position or the joint angle of the target person does not exceed a predetermined threshold value.

Thus, the information processing apparatus can generate data representing the target motion which is not unreasonable for the target person. Thus, the information processing apparatus can generate data representing the target motion.

In the eighth aspect of the present embodiment, on the premise of any one of the first to seventh aspects described above, the acceptable range may be set based on a weighting set between the first data and either one of the third data representing the reference motion state of the predetermined motion or the fourth data representing the motion state of the predetermined motion obtained by optimizing an evaluation function representing the objective of enhancement with respect to the first data. The fourth data is, for example, the above-described optimum motion data 62A.

Thus, the information processing apparatus can finely adjust by weighting how much the deviation between the first data representing the motion state in the present predetermined motion performed by the target person and either of the third data representing the direction of enhancement or the fourth data is made to approach the latter data. Therefore, the information processing apparatus can more appropriately generate data representing the target motion which is effective in enhancing the motion of the target person.

In the ninth aspect of the present embodiment, the information processing method may include obtaining data of a moving image and extracting feature points on the premise of any one of the above-described first to eighth aspects. The obtaining data of a moving image is, for example, the above-described step S108. The extracting of feature points is, for example, the above-described step S110. Specifically, in the above-described obtaining data of a moving image, the information processing apparatus may obtain data of a moving image in which the predetermined motion performed by the target person is captured. In the extracting of feature points, the information processing apparatus may extract feature points representing the predetermined motion performed by the target person, for each of the plurality of frames included in the moving image. In the obtaining of first data, the first data may be obtained based on the feature points in each of the plurality of frames.

Thus, the information processing apparatus can obtain first data representing the motion state of the target person in the predetermined motion.

In addition, in the tenth aspect of the present embodiment, the predetermined motion may be a golf swing motion on the premise of any one of the above-mentioned nine aspects.

Thus, the information processing apparatus can more appropriately generate data representing the target motion effective for enhancing the golf swing motion of the target person.

According to the above-described embodiments, data representing a target motion that is effective for enhancing the motion of a target person can be generated.

Although the embodiments have been described in detail above, the present disclosure is not limited to the specific embodiment, and various modifications and changes may be made within the scope of the gist described in the claims.

What is claimed is:

1. A computer-implemented information processing method, comprising:
obtaining first data representing a motion state of a predetermined motion performed by a target person;
determining a direction of enhancement for the first data; and
generating second data representing a target motion state of the predetermined motion, by modifying the first data to change in the direction, within an acceptable range set in advance for changing the first data.

2. The computer-implemented information processing method according to claim 1, wherein
in the determining, the direction is determined based on an evaluation function representing an objective of an enhancement of the first data.

3. The computer-implemented information processing method according to claim 2, wherein
the evaluation function is a function representing at least one of a position, an angle, energy, power, torque, angular velocity, angular acceleration, velocity, or acceleration of a predetermined body part of the target person or a tool used by the target person in the predetermined motion.

4. The computer-implemented information processing method according to claim 1, wherein
in the determining, the direction is determined to be a direction in which the first data approaches third data representing a reference motion state.

5. The computer-implemented information processing method according to claim 4, wherein
the third data is data representing the motion state included in the predetermined motion performed by a skilled person, data representing the motion state included in the predetermined motion that has been optimized based on an objective of enhancement, or data representing the motion state of the predetermined motion that has been generated from a trained model.

6. The computer-implemented information processing method according to claim 4, wherein
the first data and the third data are normalized by time between a first event and a second event in the predetermined motion.

7. The computer-implemented information processing method according to claim 1, wherein
the acceptable range is a range in which an amount of the change in at least one of a joint position or a joint angle of the target person does not exceed a predetermined threshold value.

8. The computer-implemented information processing method according to claim 1, wherein
the acceptable range is set based on a weighting set between the first data and either one of third data representing a reference motion state of the predetermined motion or fourth data representing the motion state of the predetermined motion obtained by optimizing an evaluation function representing an objective of enhancement with respect to the first data.

9. The computer-implemented information processing method according to claim 1, further comprising
obtaining data of a moving image in which the predetermined motion performed by the target person is captured; and
extracting feature points representing the predetermined motion performed by the target person, for each of a plurality of frames included in the moving image, and
wherein in the obtaining of the first data, the first data is obtained based on the feature points in each of the plurality of frames.

10. The computer-implemented information processing method according to claim 1, wherein
the predetermined motion includes a golf swing motion.

11. A non-transitory computer-readable recording medium having a program embodied therein for causing a computer to execute
obtaining first data representing a motion state of a predetermined motion performed by a target person;
determining a direction of enhancement for the first data; and
generating second data representing a target motion state of the predetermined motion, by modifying the first data to change in the direction of enhancement, within an acceptable range set in advance for changing the first data.

12. An information processing apparatus comprising:
a memory; and
one or more processors coupled to the memory and configured to obtain first data representing a motion state of a predetermined motion performed by a target person;
determine a direction of enhancement for the first data; and
generate second data representing a target motion state of the predetermined motion, by modifying the first data to change in the direction of enhancement, within an acceptable range set in advance for changing the first data.
